(19) United States
(12) Patent Application Publication
(10) Pub. No.: US 2026/0360285 A1
(43) Pub. Date: Nov. 12, 2026

(54) METHOD FOR DRIVING MICRO LIGHT EMITTING DIODE PANEL

(71) Applicant: AUO Corporation, Hsinchu City (TW)

(72) Inventors: Kuo-Tung LIN, Hsinchu City (TW); Hsien-Hung Chen, Hsinchu City (TW); Wen-Chiuan Su, Hsinchu City (TW)

(21) Appl. No.: 19/670,521

(22) Filed: May 7, 2026

(30) Foreign Application Priority Data
May 12, 2025 (TW) 114117764

(51) Int. Cl. G09G 3/00; G09G 3/32

(52) U.S. Cl. CPC G09G 3/006; G09G 3/32; G09G 2330/10; G09G 2330/12

(57) ABSTRACT

A method for driving a micro light emitting diode panel includes: determining whether the light emitting elements of the micro light emitting diode panel are abnormal, and the light emitting elements include light emitting elements emitting a first color light, light emitting elements emitting a second color light, and light emitting elements emitting a third color light that are arranged in a first configuration to form first pixel units, and the first color light, the second color light and the third color light are all different; in response to at least one of the light emitting elements is abnormal, disabling the at least one abnormal light emitting element and the corresponding light emitting elements; reconfiguring the non-disabled light emitting elements from the first configuration into a second configuration to form second pixel units; adjusting the driving currents provided to the non-disabled light emitting elements according to the second configuration.

### CROSS - REFERENCE TO RELATED APPLICATION

This application claims priority to Taiwan Application Serial Number 114117764, filed May 12, 2025, which is herein incorporated by reference in its entirety.

### BACKGROUND

### Field of Invention

The present disclosure relates to a method for driving a display panel. More particularly, the present disclosure relates to a method for driving a micro light emitting diode panel.

### Description of Related Art

With advances in optoelectronic technology, optoelectronic components are becoming increasingly compact. Compared to organic light emitting diodes (OLEDs), micro light emitting diodes (micro LEDs) offer advantages such as high efficiency, longer lifespan, and greater stability due to materials that are less susceptible to environmental influences. Therefore, displays using micro light emitting diodes arranged in arrays are gaining increasing attention in the market.

However, because the manufacturing temperature for micro light emitting diodes is higher than that for liquid crystal display panels or organic light emitting diode panels, they cannot be formed directly on a glass substrate. The most common approach today is to first fabricate the micro light emitting diodes on a carrier substrate and then use mass transfer technology to transfer them onto the glass substrate. However, because there are a large number of micro light emitting diodes, some may fail to emit light or exhibit lower-than-expected luminous efficiency during the transfer process due to poor contact or other factors, resulting in defective sub-pixels in the display area of the panel.

The conventional approach to addressing the defective sub-pixels involves a repair process in which the defective micro light emitting diodes are individually removed, and new micro light emitting diodes are then individually disposed in their place. However, micro light emitting diode displays typically include hundreds of thousands or even millions of micro light emitting diodes. If the aforementioned method were used to repair each defective sub-pixel individually, the repair process would be time-consuming and not cost-effective. In addition, since the repair is not performed at the original location of the defective sub-pixel but is slightly shift, the repaired micro light emitting diodes and the adjacent micro light emitting diodes may appear to create mura effect during display, resulting in a decrease in display quality.

### SUMMARY

At least one embodiment of the present disclosure provides a method for driving a micro light emitting diode panel to solve the above-mentioned problem. The method includes: determining whether multiple light emitting elements included in the micro light emitting diode panel are abnormal, and the light emitting elements include multiple light emitting elements emitting a first color light, multiple light emitting elements emitting a second color light and multiple light emitting elements emitting a third color light, where the light emitting elements are arranged in a first configuration to form multiple first pixel units, and the first color light, the second color light and the third color light are all different; in response to at least one of the light emitting elements is abnormal, disabling the at least one of the light emitting elements and a portion of the light emitting elements corresponding to the at least one of the light emitting elements; reconfiguring the light emitting elements being non-disabled from the first configuration into a second configuration to form multiple second pixel units; and adjusting driving currents provided to the light emitting elements being non-disabled according to the second configuration.

In the above-mentioned embodiment, the method for driving a micro light emitting diode panel disclosed herein initially provides the first pixel unit on the micro light emitting diode panel that may include multiple light emitting elements emitting the same color light as sub-pixels. Once a defective sub-pixel occurs, the light emitting elements at the location of the defective sub-pixel and at the corresponding locations can be disabled, and the non-disabled light emitting elements can be reconfigured to form a regularly arranged second pixel unit to display the image, thereby avoiding mura formation. Since there is no need to repair the light emitting elements at the corresponding defective sub-pixel locations, the complexity and time required for the manufacturing process can be significantly reduced. Furthermore, even if a micro light emitting diode panel has been manufactured and defective sub-pixels have formed after a period of use, the image can still be displayed by reconfiguring the pixel units, and mura formation can be avoided.

### BRIEF DESCRIPTION OF THE DRAWINGS

The embodiments of the present disclosure can be understood from the following detailed description and accompanying drawings. It should be noted that many features are not drawn to industry-standard scale. In fact, for the sake of clarity and ease of understanding, the dimensions of various features may be arbitrarily increased or decreased.

FIG. 1 is a flowchart illustrating a method for driving a micro light emitting diode panel according to at least one embodiment of the present disclosure.

FIG. 2A is a schematic diagram illustrating a first pixel unit configured in a first configuration according to at least one embodiment of the present disclosure.

FIG. 2B is a schematic diagram illustrating a second pixel unit configured in a second configuration reconfigured from the first pixel unit shown in FIG. 2A according to at least one embodiment of the present disclosure.

FIG. 2C is a schematic diagram illustrating a second pixel unit configured in a second configuration reconfigured from the first pixel unit shown in FIG. 2A according to at least another embodiment of the present disclosure.

FIG. 2D is a schematic diagram illustrating a second pixel unit configured in a second configuration reconfigured from the first pixel unit shown in FIG. 2A according to at least another embodiment of the present disclosure.

FIG. 2E is a schematic diagram illustrating a second pixel unit configured in a second configuration reconfigured from the first pixel unit shown in FIG. 2A according to at least another embodiment of the present disclosure.

FIG. 3A is a schematic diagram illustrating a first pixel unit configured in a first configuration according to at least another embodiment of the present disclosure.

FIG. 3B is a schematic diagram illustrating a second pixel unit configured in a second configuration reconfigured from the first pixel unit shown in FIG. 3A according to at least one embodiment of the present disclosure.

FIG. 3C is a schematic diagram illustrating a second pixel unit configured in a second configuration reconfigured from the first pixel unit shown in FIG. 3A according to at least another embodiment of the present disclosure.

FIG. 3D is a schematic diagram illustrating a second pixel unit configured in a second configuration reconfigured from the first pixel unit shown in FIG. 3A according to at least another embodiment of the present disclosure.

FIG. 4A is a schematic diagram illustrating a first pixel unit configured in a first configuration according to at least another embodiment of the present disclosure.

FIG. 4B is a schematic diagram illustrating a second pixel unit configured in a second configuration reconfigured from the first pixel unit shown in FIG. 4A according to at least one embodiment of the present disclosure.

FIG. 4C is a schematic diagram illustrating a second pixel unit configured in a second configuration reconfigured from the first pixel unit shown in FIG. 4A according to at least another embodiment of the present disclosure.

FIG. 4D is a schematic diagram illustrating a second pixel unit configured in a second configuration reconfigured from the first pixel unit shown in FIG. 4A according to at least another embodiment of the present disclosure.

FIG. 4E is a schematic diagram illustrating a second pixel unit configured in a second configuration reconfigured from the first pixel unit shown in FIG. 4A according to at least another embodiment of the present disclosure.

FIG. 5A is a schematic diagram illustrating a first pixel unit configured in a first configuration according to at least another embodiment of the present disclosure.

FIG. 5B is a schematic diagram illustrating a second pixel unit configured in a second configuration reconfigured from the first pixel unit shown in FIG. 5A according to at least one embodiment of the present disclosure.

FIG. 5C is a schematic diagram illustrating a second pixel unit configured in a second configuration reconfigured from the first pixel unit shown in FIG. 5A according to at least another embodiment of the present disclosure.

FIG. 5D is a schematic diagram illustrating a second pixel unit configured in a second configuration reconfigured from the first pixel unit shown in FIG. 5A according to at least another embodiment of the present disclosure.

FIG. 5E is a schematic diagram illustrating a second pixel unit configured in a second configuration reconfigured from the first pixel unit shown in FIG. 5A according to at least another embodiment of the present disclosure.

### DETAILED DESCRIPTION

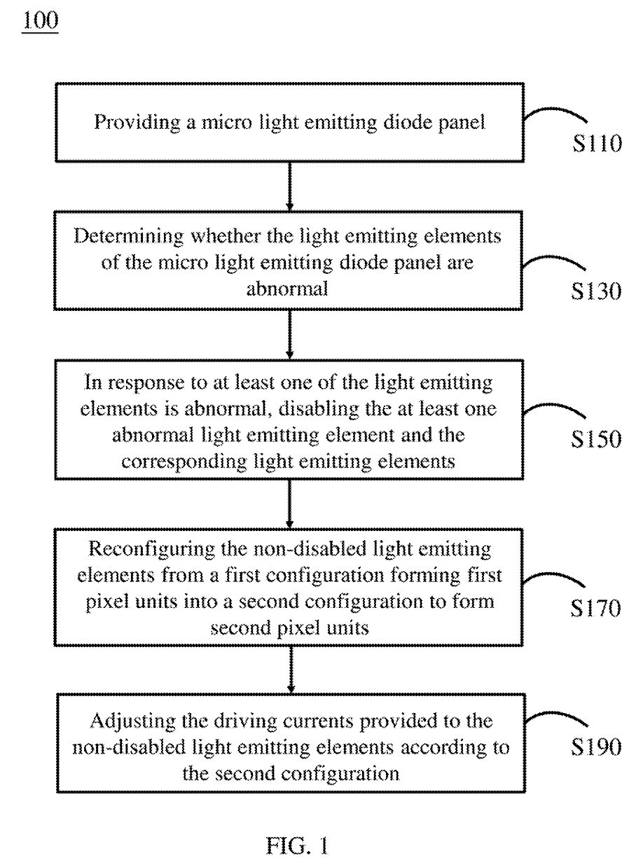

FIG. 1 is a flowchart illustrating a method 100 for driving a micro light emitting diode panel according to at least one embodiment of the present disclosure. First, in step S110, a micro light emitting diode panel is provided. In one embodiment, the micro light emitting diode panel may include a transparent substrate and multiple light emitting elements, multiple switches, at least one first driving circuit, at least one second driving circuit and a controller disposed on the transparent substrate. In this embodiment, the light emitting elements may be micro light emitting diodes, and include multiple light emitting elements emitting a first color light (e.g., blue light), multiple light emitting elements emitting a second color light (e.g., green light) and multiple light emitting elements emitting a third color light (e.g., red light). In other words, the first color light, the second color light, and the third color light are all different. In another embodiment, the light emitting elements may further include multiple light emitting elements emitting a fourth color of light (e.g., white light), and the present disclosure is not limited thereto.

The switches may be thin film transistors (TFTs). Each switch may have a first terminal, a second terminal, and a third terminal. The first terminal is electrically connected to the corresponding light emitting element. The second terminal is electrically connected to the first driving circuit via a scan line to receive a scan signal. The third terminal is electrically connected to the second driving circuit via a data line to receive a data signal. When the scan signal provided by the first driving circuit activates the corresponding switch, the activated switch can transmit the data signal provided by the second driving circuit to the corresponding light emitting element, and the light emitting element emits a corresponding brightness according to the current magnitude of the corresponding data signal to form a display image. The controller can control when the first driving circuit and the second driving circuit provide the scan signal and the data signal, respectively.

In this embodiment, all the light emitting elements included in the micro light emitting diode panel are configured into multiple first pixel units in a first configuration, the specific details will be described later.

Next, in step S130, it is to determine whether the light emitting elements included in the micro light emitting diode panel are abnormal. In this description, the light emitting element being abnormal is defined as a situation where the light emitting element fails to emit light or fails to emit the corresponding brightness when a normal data signal is provided. In one embodiment, the abnormality can be determined by providing a current signal to the light emitting element and measuring its electrical characteristics, or by using optical instruments to receive the brightness of the light emitting element, the present disclosure is not limited thereto.

Next, in step S150, in response to at least one of the light emitting elements is abnormal, the at least one abnormal light emitting element and the corresponding light emitting elements are disabled. In this description, “being disabled” means that the light emitting element cannot emit light even when supplied with any current. In one embodiment, a light emitting element may be disabled by directly turning off the switch connected to it.

Next, in step S170, the non-disabled light emitting elements in the micro light emitting diode panel are reconfigured from the first configuration into a second configuration to form multiple second pixel units.

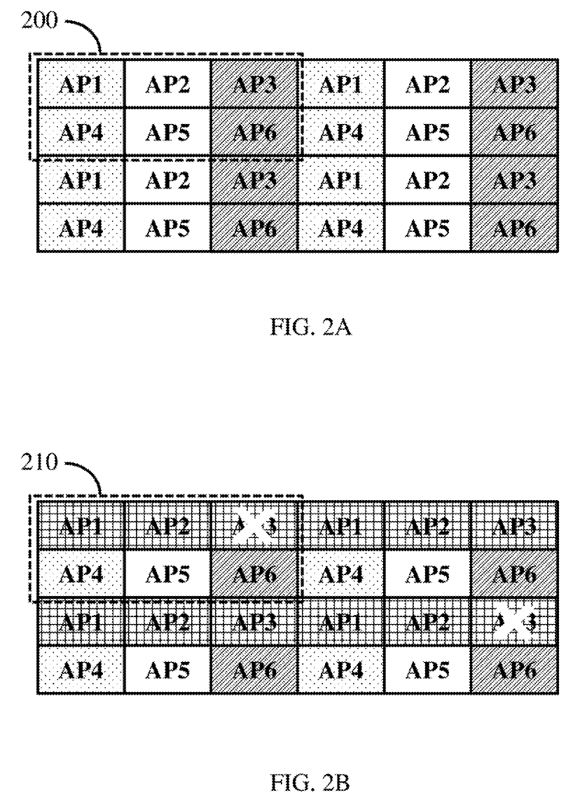

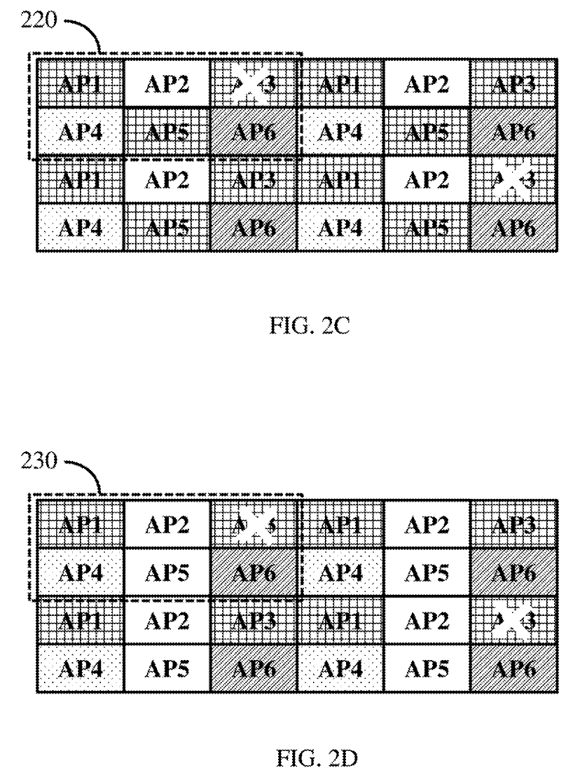

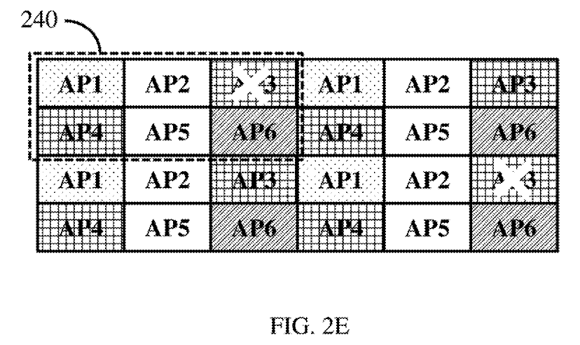

Referring to FIGS. 2A-2E , FIG. 2A is a schematic diagram illustrating a first pixel unit 200 configured in a first configuration according to at least one embodiment of the present disclosure. FIG. 2B is a schematic diagram illustrating a second pixel unit 210 configured in a second configuration reconfigured from the first pixel unit shown in FIG. 2A according to at least one embodiment of the present disclosure. FIG. 2C is a schematic diagram illustrating a second pixel unit 220 configured in a second configuration reconfigured from the first pixel unit shown in FIG. 2A according to at least another embodiment of the present disclosure. FIG. 2D is a schematic diagram illustrating a second pixel unit 230 configured in a second configuration reconfigured from the first pixel unit shown in FIG. 2A according to at least another embodiment of the present disclosure. FIG. 2E is a schematic diagram illustrating a second pixel unit 240 configured in a second configuration reconfigured from the first pixel unit shown in FIG. 2A according to at least another embodiment of the present disclosure.

In FIG. 2A, each first pixel unit 200 of the micro light emitting diode panel is configured according to the first configuration to include light emitting elements AP1, AP2, AP3, AP4, AP5, AP6. The light emitting elements AP1, AP2, AP3 are arranged sequentially in the same row, and the light emitting elements AP4, AP5, AP6 are arranged sequentially in the same row but in a different row from the light emitting elements AP1, AP2, AP3. The light emitting elements AP1, AP4 are arranged in the same column and emit the first color light (e.g., blue light, represented by dots). The light emitting elements AP2, AP5 are arranged in the same column and emit the second color light (e.g., green light, represented by blank spaces). The light emitting elements AP3, AP6 are arranged in the same column and emit the third color light (e.g., red light, represented by slashes). In other words, the first configuration in FIG. 2A is an RGB stripe arrangement.

Specifically, in this embodiment, the first pixel unit 200, also referred to as the initial pixel unit, is not like a conventional pixel unit that only includes one red sub-pixel, one green sub-pixel, and one blue sub-pixel, but can include multiple sub-pixels of the same color (each sub-pixel is displayed by using a light emitting element). For example, in this embodiment, the first pixel unit 200 may include two red sub-pixels, two green sub-pixels, and two blue sub-pixels. Therefore, once a defective sub-pixel occurs, the light emitting elements at the location of the defective sub-pixel and at the corresponding locations can be disabled, and the non-disabled light emitting elements can be reconfigured to form a regularly arranged pixel unit to display the image, thereby avoiding mura formation. Since there is no need to repair the light emitting elements at the corresponding defective sub-pixel locations, the complexity and time required for the manufacturing process can be significantly reduced. Furthermore, even if a micro light emitting diode panel has been manufactured and defective sub-pixels have formed after a period of use, the image can still be displayed by reconfiguring the pixel units, and mura formation can be avoided.

The reconfigured pixel units are shown in FIGS. 2B-2E . For example, in FIG. 2B, each first pixel unit 200 is reconfigured from the first configuration into the second configuration to form the second pixel unit 210, and the second pixel unit 210 includes the light emitting elements AP1, AP2, AP3, AP4, AP5, AP6. Assuming that the light emitting element AP3 is a defective sub-pixel (indicated by an “X”), the light emitting element AP3, along with the light emitting elements AP1, AP2, will be disabled (indicated by grids), even if the light emitting elements AP1, AP2 are functioning normally. In this way, the second pixel unit 210 only uses the light emitting elements AP4, AP5, AP6 as a single pixel for display. Similarly, if the light emitting element AP6 is a defective sub-pixel (not shown), the light emitting element AP6, along with the light emitting elements AP4, AP5, will be disabled. In this case, the second pixel unit 210 only uses the light emitting elements AP1, AP2, AP3 as a single pixel for display. The same principle applies to defective sub-pixels in other locations, and will not be repeated here. In this embodiment, the second configuration is also an RGB strip arrangement, but compared to the first pixel unit 200, the second pixel unit 210 includes one red sub-pixel, one green sub-pixel, and one blue sub-pixel.

In another embodiment, as shown in FIG. 2C, each first pixel unit 200 is reconfigured from the first configuration into the second configuration to form the second pixel unit 220, and the second pixel unit 220 includes the light emitting elements AP1, AP2, AP3, AP4, AP5, AP6. Assuming that the light emitting element AP3 is a defective sub-pixel (indicated by an “X”), the light emitting element AP3, along with the light emitting elements AP1, AP5, will be disabled (indicated by grids). In this way, the second pixel unit 220 only uses the light emitting elements AP2, AP4, AP6 as a single pixel for display. Similarly, if the light emitting element AP6 is a defective sub-pixel (not shown), the light emitting element AP6, along with the light emitting elements AP2, AP4, will be disabled. In this case, the second pixel unit 220 only uses the light emitting elements AP1, AP3, AP5 as a single pixel for display. The same principle applies to defective sub-pixels in other locations, and will not be repeated here. In this embodiment, the second configuration is similar to an RGB strip arrangement, but the middle sub-pixel is staggered from its two adjacent sub-pixels.

In another embodiment, as shown in FIG. 2D, each first pixel unit 200 is reconfigured from the first configuration into the second configuration to form the second pixel unit 230, and the second pixel unit 230 includes the light emitting elements AP1, AP2, AP3, AP4, AP5, AP6. Assuming that the light emitting element AP3 is a defective sub-pixel (indicated by an “X”), the light emitting element AP3, along with the light emitting element AP1, will be disabled (indicated by grids). In this way, the second pixel unit 230 only uses the light emitting elements AP2, AP4, AP5, AP6 as a single pixel for display. Similarly, if the light emitting element AP6 is a defective sub-pixel (not shown), the light emitting element AP6, along with the light emitting element AP4, will be disabled. In this case, the second pixel unit 230 only uses the light emitting elements AP1, AP2, AP3, AP5 as a single pixel for display. The same principle applies to defective sub-pixels in other locations, and will not be repeated here. In this embodiment, the second configuration is similar to an RGB strip arrangement, but one sub-pixel uses two light emitting elements. In this embodiment, the second pixel unit 230 includes one red sub-pixel, one blue sub-pixel, and two green sub-pixels. However, those skilled in the art can make appropriate modifications and adjustments according to the actual situation, and the present disclosure is not limited thereto.

In another embodiment, as shown in FIG. 2E, each first pixel unit 200 is reconfigured from the first configuration into the second configuration to form the second pixel unit 240, and the second pixel unit 240 includes the light emitting elements AP1, AP2, AP3, AP4, AP5, AP6. Assuming that the light emitting element AP3 is a defective sub-pixel (indicated by an “X”), the light emitting element AP3, along with the light emitting element AP4, will be disabled (indicated by grids). In this way, the second pixel unit 240 only uses the light emitting elements AP1, AP2, AP5, AP6 as a single pixel for display. Similarly, if the light emitting element AP6 is a defective sub-pixel (not shown), the light emitting element AP6, along with the light emitting element AP1, will be disabled. In this case, the second pixel unit 240 only uses the light emitting elements AP2, AP3, AP4, AP5 as a single pixel for display. The same principle applies to defective sub-pixels in other locations, and will not be repeated here. In this embodiment, the second configuration is similar to an RGB strip arrangement, but one sub-pixel uses two light emitting elements, and two sub-pixel adjacent to the sub-pixel using two light emitting elements are staggered.

Referring to FIG. 1, after reconfiguring the non-disabled light emitting elements from the first configuration forming first pixel units into the second configuration to form second pixel units, in step S190, it is to adjust the driving currents provided to the non-disabled light emitting elements according to the second configuration. Since the number of light emitting elements in the second pixel unit that can emit light is less than the number of light emitting elements in the first pixel unit that can emit light, the brightness of the micro light emitting diode panel in the second configuration can be compensated by increasing the brightness emitted by the light emitting elements in the second pixel unit, so that the display quality in the second configuration is not too different from the display quality in the first configuration. In one embodiment, the brightness of the light emitting element can be adjusted by controlling the scan signal of the first driving circuit or the data signal of the second driving circuit through the controller. For example, the controller can use pulse amplitude modulation (PAM) to increase the amplitude of the data signal, or use pulse width modulation (PWM) to increase the width of the scan signal to increase the switch on time, thereby increasing the brightness of the light emitting element.

In some embodiments, when selecting the second configuration shown in FIGS. 2B-2E, a configuration with a minimum total number of the light emitting elements being disabled to form the second pixel units is preferred. For example, in the second pixel unit 230 in FIG. 2D or in the second pixel unit 240 in FIG. 2E, the number of the light emitting elements being disabled is two. In contrast, in the second pixel unit 210 in FIG. 2B or in the second pixel unit 220 in FIG. 2C, the number of the light emitting elements being disabled is three. Therefore, in such cases, the method 100 for driving a micro light emitting diode panel according to at least one embodiment of the present disclosure will preferentially configure the non-disabled light emitting elements as the second pixel unit in the second configuration of FIG. 2D or FIG. 2E.

The following will describe various embodiments of different first configurations and the corresponding second configurations.

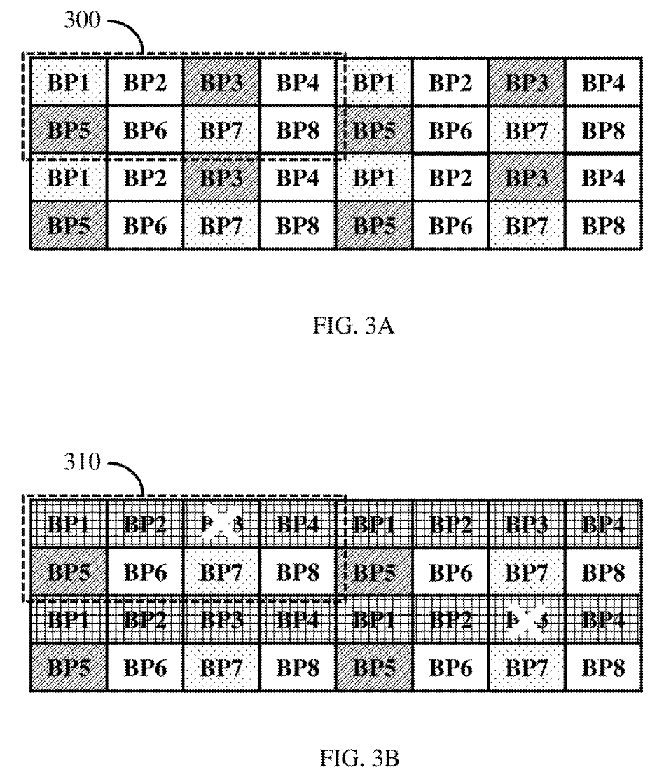

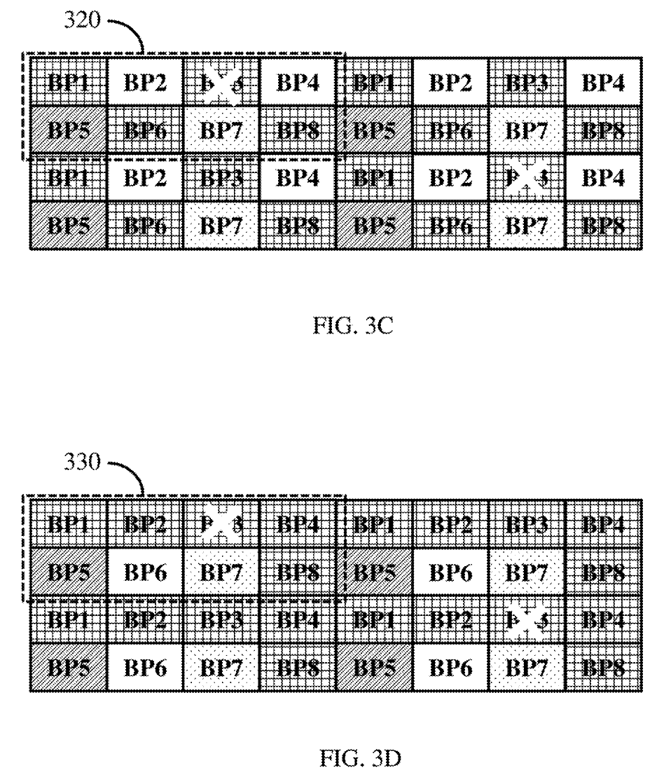

Referring to FIGS. 3A-3D, FIG. 3A is a schematic diagram illustrating a first pixel unit 300 configured in a first configuration according to at least another embodiment of the present disclosure. FIG. 3B is a schematic diagram illustrating a second pixel unit 310 configured in a second configuration reconfigured from the first pixel unit shown in FIG. 3A according to at least one embodiment of the present disclosure. FIG. 3C is a schematic diagram illustrating a second pixel unit 320 configured in a second configuration reconfigured from the first pixel unit shown in FIG. 3A according to at least another embodiment of the present disclosure. FIG. 3D is a schematic diagram illustrating a second pixel unit 330 configured in a second configuration reconfigured from the first pixel unit shown in FIG. 3A according to at least another embodiment of the present disclosure.

In FIG. 3A, each first pixel unit 300 of the micro light emitting diode panel is configured according to the first configuration to include light emitting elements BP1, BP2, BP3, BP4, BP5, BP6, BP7, BP8. The light emitting elements BP1, BP2, BP3, BP4 are arranged sequentially in the same row, and the light emitting elements BP5, BP6, BP7, BP8 are arranged sequentially in the same row but in a different row from the light emitting elements BP1, BP2, BP3, BP4. The light emitting elements BP1, BP5 are arranged in the same column, the light emitting elements BP2, BP6 are arranged in the same column, the light emitting elements BP3, BP7 are arranged in the same column, and the light emitting elements BP4, BP8 are arranged in the same column. The light emitting elements BP1, BP7 emit the first color light (e.g., blue light, represented by dots), the light emitting elements BP2, BP4, BP6, BP8 emit the second color light (e.g., green light, represented by blank spaces), and the light emitting elements BP3, BP5 emit the third color light (e.g., red light, represented by slashes). In this embodiment, the first configuration in FIG. 3A is a pentile arrangement, in which the green sub-pixels between the blue sub-pixel and the red sub-pixel are shared by the blue sub-pixel and the red sub-pixel.

In FIG. 3B, each first pixel unit 300 is reconfigured from the first configuration into the second configuration to form the second pixel unit 310, and the second pixel unit 310 includes the light emitting elements BP1, BP2, BP3, BP4, BP5, BP6, BP7, BP8. Assuming that the light emitting element BP3 is a defective sub-pixel (indicated by an “X”), the light emitting element BP3, along with the light emitting elements BP1, BP2, BP4, will be disabled (indicated by grids), even if the light emitting elements BP1, BP2, BP4 are functioning normally. In this way, the second pixel unit 310 only uses the light emitting elements BP5, BP6, BP7, BP8 as a single pixel for display. Similarly, if the light emitting element BP7 is a defective sub-pixel (not shown), the light emitting element BP7, along with the light emitting elements BP5, BP6, BP8, will be disabled. In this case, the second pixel unit 310 only uses the light emitting elements BP1, BP2, BP3, BP4 as a single pixel for display. The same principle applies to defective sub-pixels in other locations, and will not be repeated here. In this embodiment, the second configuration is also a pentile arrangement, but compared to the first pixel unit 300, the second pixel unit 310 includes one red sub-pixel, one blue sub-pixel, and two green sub-pixels.

In another embodiment, as shown in FIG. 3C, each first pixel unit 300 is reconfigured from the first configuration into the second configuration to form the second pixel unit 320, and the second pixel unit 320 includes the light emitting elements BP1, BP2, BP3, BP4, BP5, BP6, BP7, BP8. Assuming that the light emitting element BP3 is a defective sub-pixel (indicated by an “X”), the light emitting element BP3, along with the light emitting elements BP1, BP6, BP8, will be disabled (indicated by grids). In this way, the second pixel unit 320 only uses the light emitting elements BP2, BP4, BP5, BP7 as a single pixel for display. Similarly, if the light emitting element BP7 is a defective sub-pixel (not shown), the light emitting element BP7, along with the light emitting elements BP2, BP4, BP5, will be disabled. In this case, the second pixel unit 320 only uses the light emitting elements BP1, BP3, BP6, BP8 as a single pixel for display. The same principle applies to defective sub-pixels in other locations, and will not be repeated here. In this embodiment, the second configuration is also a pentile arrangement, but compared to the first pixel unit 300, the red sub-pixel and the blue sub-pixel of the second pixel unit 320 are staggered with the green sub-pixels located in between.

In another embodiment, as shown in FIG. 3D, each first pixel unit 300 is reconfigured from the first configuration into the second configuration to form the second pixel unit 330, and the second pixel unit 330 includes the light emitting elements BP1, BP2, BP3, BP4, BP5, BP6, BP7, BP8. Assuming that the light emitting element BP3 is a defective sub-pixel (indicated by an “X”), the light emitting element BP3, along with the light emitting elements BP1, BP2, BP4, BP8, will be disabled (indicated by grids). In this way, the second pixel unit 330 only uses the light emitting elements BP5, BP6, BP7 as a single pixel for display. Similarly, if the light emitting element BP7 is a defective sub-pixel (not shown), the light emitting element BP7, along with the light emitting elements BP4, BP5, BP6, BP8, will be disabled. In this case, the second pixel unit 330 only uses the light emitting elements BP1, BP2, BP3 as a single pixel for display. The same principle applies to defective sub-pixels in other locations, and will not be repeated here. In this embodiment, the second configuration is an RGB strip arrangement, and the second pixel unit 330 includes one red sub-pixel, one green sub-pixel, and one blue sub-pixel.

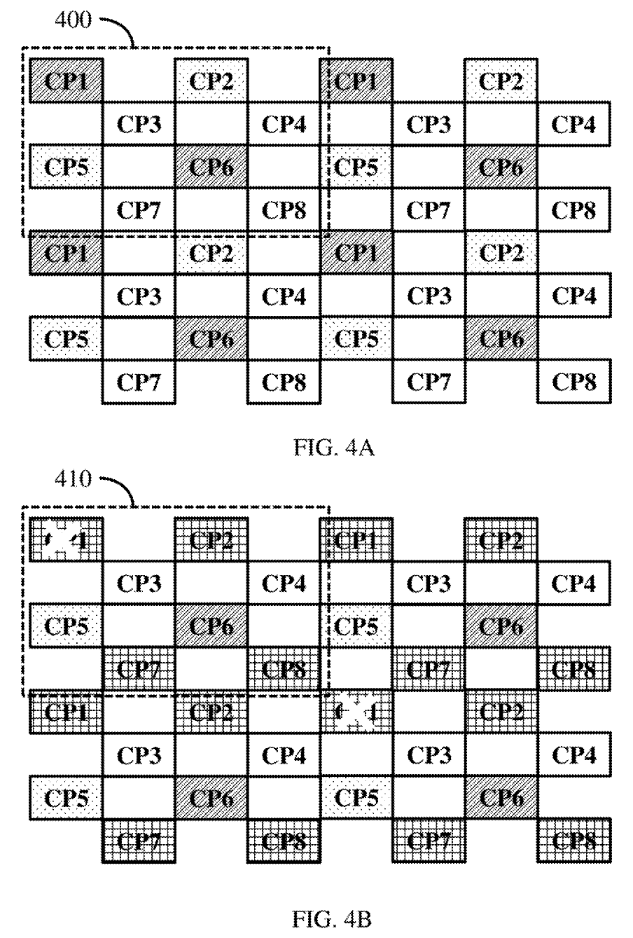

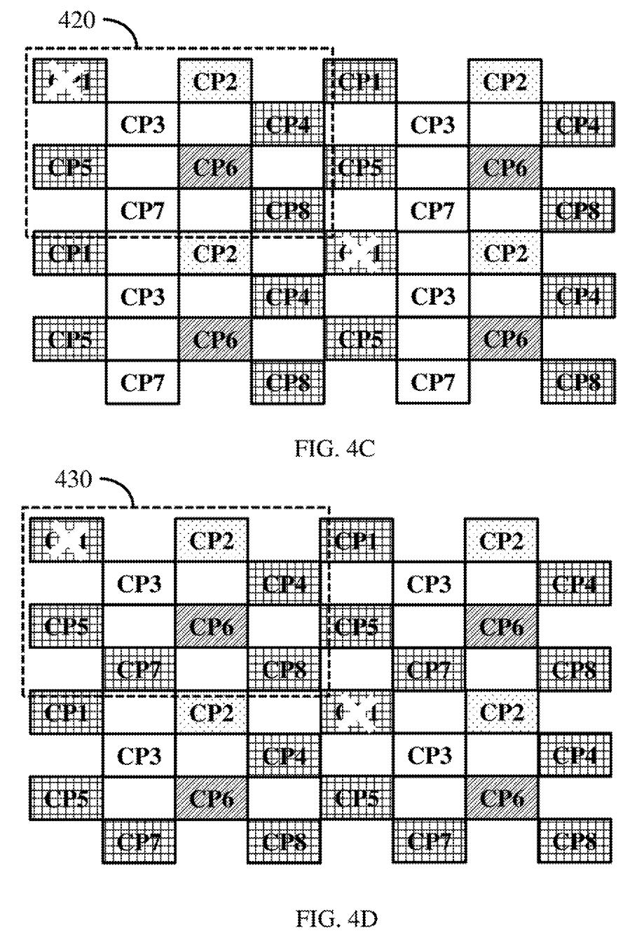

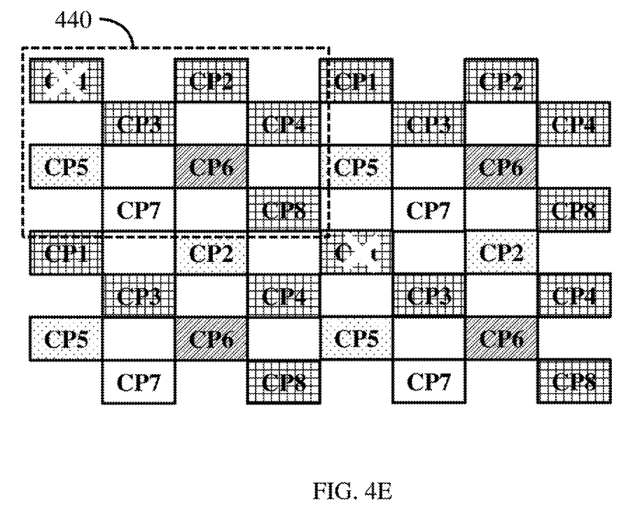

Referring to FIGS. 4A-4E , FIG. 4A is a schematic diagram illustrating a first pixel unit 400 configured in a first configuration according to at least one embodiment of the present disclosure. FIG. 4B is a schematic diagram illustrating a second pixel unit 410 configured in a second configuration reconfigured from the first pixel unit shown in FIG. 4A according to at least one embodiment of the present disclosure. FIG. 4C is a schematic diagram illustrating a second pixel unit 420 configured in a second configuration reconfigured from the first pixel unit shown in FIG. 4A according to at least another embodiment of the present disclosure. FIG. 4D is a schematic diagram illustrating a second pixel unit 430 configured in a second configuration reconfigured from the first pixel unit shown in FIG. 4A according to at least another embodiment of the present disclosure. FIG. 4E is a schematic diagram illustrating a second pixel unit 440 configured in a second configuration reconfigured from the first pixel unit shown in FIG. 4A according to at least another embodiment of the present disclosure.

In FIG. 4A, each first pixel unit 400 of the micro light emitting diode panel is configured according to the first configuration to include light emitting elements CP1, CP2, CP3, CP4, CP5, CP6, CP7, CP8. The light emitting elements CP1, CP2 are arranged sequentially in the same row, the light emitting elements CP3, CP4 are arranged sequentially in the same row, the light emitting elements CP5, CP6 are arranged sequentially in the same row, and the light emitting elements CP7, CP8 are arranged sequentially in the same row. The light emitting elements CP1, CP5 are arranged in the same column, the light emitting elements CP2, CP6 are arranged in the same column, the light emitting elements CP3, CP7 are arranged in the same column, and the light emitting elements CP4, CP8 are arranged in the same column. The light emitting elements CP1, CP3, CP5 are in different rows, and the light emitting elements CP1, CP2, CP3 are in different columns. The light emitting elements CP3, CP6, CP7 are in different rows, and the light emitting elements CP3, CP4, CP6 are in different columns. The light emitting element CP3 is disposed between the light emitting elements CP1, CP2, CP5, CP6, and the light emitting element CP6 is disposed between the light emitting elements CP3, CP4, CP7, CP8. The light emitting elements CP2, CP5 emit the first color light (e.g., blue light, represented by dots), the light emitting elements CP3, CP4, CP7, BP8 emit the second color light (e.g., green light, represented by blank spaces), and the light emitting elements CP1, CP6 emit the third color light (e.g., red light, represented by slashes). In this embodiment, the first configuration in FIG. 4A is a diamond-shaped arrangement, in which each blue or red sub-pixel is surrounded by four green sub-pixels at its four corners, and each green sub-pixel is surrounded by two red sub-pixels and two blue sub-pixels at its four corners.

In FIG. 4B, each first pixel unit 400 is reconfigured from the first configuration into the second configuration to form the second pixel unit 410, and the second pixel unit 410 includes the light emitting elements CP1, CP2, CP3, CP4, CP5, CP6, CP7, CP8. Assuming that the light emitting element CP1 is a defective sub-pixel (indicated by an “X”), the light emitting element CP1, along with the light emitting elements CP2, CP7, CP8, will be disabled (indicated by grids), even if the light emitting elements CP2, CP7, CP8 are functioning normally. In this way, the second pixel unit 410 only uses the light emitting elements CP3, CP4, CP5, CP6 as a single pixel for display. Alternatively, the light emitting element CP3, along with the light emitting elements CP1, CP2, CP4, will be disabled, and the second pixel unit 410 only uses the light emitting elements CP5, CP6, CP7, CP8 as a single pixel for display. Similarly, if the light emitting element CP5 is a defective sub-pixel (not shown), the light emitting element CP5, along with the light emitting elements CP6, CP7, CP8, will be disabled. In this case, the second pixel unit 410 only uses the light emitting elements CP1, CP2, CP3, CP4 as a single pixel for display. The same principle applies to defective sub-pixels in other locations, and will not be repeated here. In this embodiment, two adjacent second pixel units 410 arranged in the second configuration may form a diamond-shaped arrangement.

In another embodiment, as shown in FIG. 4C, each first pixel unit 400 is reconfigured from the first configuration into the second configuration to form the second pixel unit 420, and the second pixel unit 420 includes the light emitting elements CP1, CP2, CP3, CP4, CP5, CP6, CP7, CP8. Assuming that the light emitting element CP1 is a defective sub-pixel (indicated by an “X”), the light emitting element CP1, along with the light emitting elements CP4, CP5, CP8, will be disabled (indicated by grids). In this way, the second pixel unit 420 only uses the light emitting elements CP2, CP3, CP6, CP7 as a single pixel for display. Alternatively, the light emitting element CP1, along with the light emitting elements CP3, CP5, CP7, will be disabled, and the second pixel unit 420 only uses the light emitting elements CP2, CP4, CP6, CP8 as a single pixel for display. Similarly, if the light emitting element CP2 is a defective sub-pixel (not shown), the light emitting element CP2, along with the light emitting elements CP4, CP6, CP8, will be disabled. In this case, the second pixel unit 420 only uses the light emitting elements CP1, CP3, CP5, CP7 as a single pixel for display. The same principle applies to defective sub-pixels in other locations, and will not be repeated here. In this embodiment, two adjacent second pixel units 420 arranged in the second configuration may form a diamond-shaped arrangement.

In another embodiment, as shown in FIG. 4D, each first pixel unit 400 is reconfigured from the first configuration into the second configuration to form the second pixel unit 430, and the second pixel unit 430 includes the light emitting elements CP1, CP2, CP3, CP4, CP5, CP6, CP7, CP8. Assuming that the light emitting element CP1 is a defective sub-pixel (indicated by an “X”), the light emitting element CP1, along with the light emitting elements CP4, CP5, CP7, CP8, will be disabled (indicated by grids). In this way, the second pixel unit 430 only uses the light emitting elements CP2, CP3, CP6 as a single pixel for display. Alternatively, the light emitting element CP1, along with the light emitting elements CP3, CP5, CP7, CP8, will be disabled, and the second pixel unit 430 only uses the light emitting elements CP2, CP4, CP6 as a single pixel for display. Similarly, if the light emitting element CP2 is a defective sub-pixel (not shown), the light emitting element CP2, along with the light emitting elements CP4, CP6, CP7, CP8, will be disabled. In this case, the second pixel unit 430 only uses the light emitting elements CP1, CP3, CP5 as a single pixel for display. The same principle applies to defective sub-pixels in other locations, and will not be repeated here. In this embodiment, the second configuration is an RGB strip arrangement, and the second pixel unit 430 includes one red sub-pixel, one green sub-pixel, and one blue sub-pixel.

In another embodiment, as shown in FIG. 4E, each first pixel unit 400 is reconfigured from the first configuration into the second configuration to form the second pixel unit 440, and the second pixel unit 440 includes the light emitting elements CP1, CP2, CP3, CP4, CP5, CP6, CP7, CP8. Assuming that the light emitting element CP1 is a defective sub-pixel (indicated by an “X”), the light emitting element CP1, along with the light emitting elements CP2, CP3, CP4, CP8, will be disabled (indicated by grids). In this way, the second pixel unit 440 only uses the light emitting elements CP5, CP6, CP7 as a single pixel for display. Alternatively, the light emitting element CP1, along with the light emitting elements CP2, CP4, CP7, CP8, will be disabled, and the second pixel unit 440 only uses the light emitting elements CP3, CP5, CP6 as a single pixel for display. Similarly, if the light emitting element CP5 is a defective sub-pixel (not shown), the light emitting element CP5, along with the light emitting elements CP4, CP6, CP7, CP8, will be disabled. In this case, the second pixel unit 440 only uses the light emitting elements CP1, CP2, CP3 as a single pixel for display. The same principle applies to defective sub-pixels in other locations, and will not be repeated here. In this embodiment, the second configuration is an RGB strip arrangement, and the second pixel unit 440 includes one red sub-pixel, one green sub-pixel, and one blue sub-pixel.

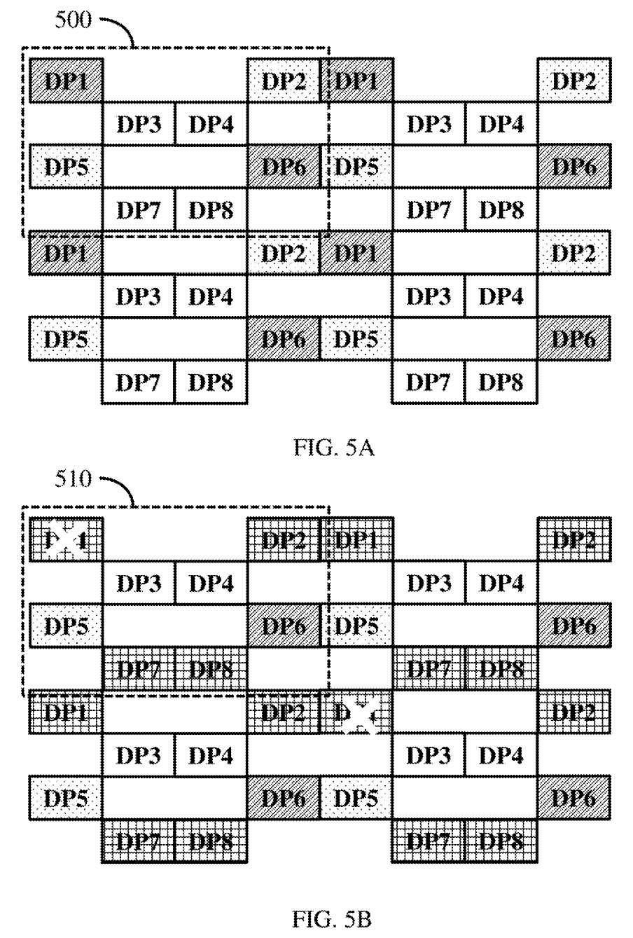

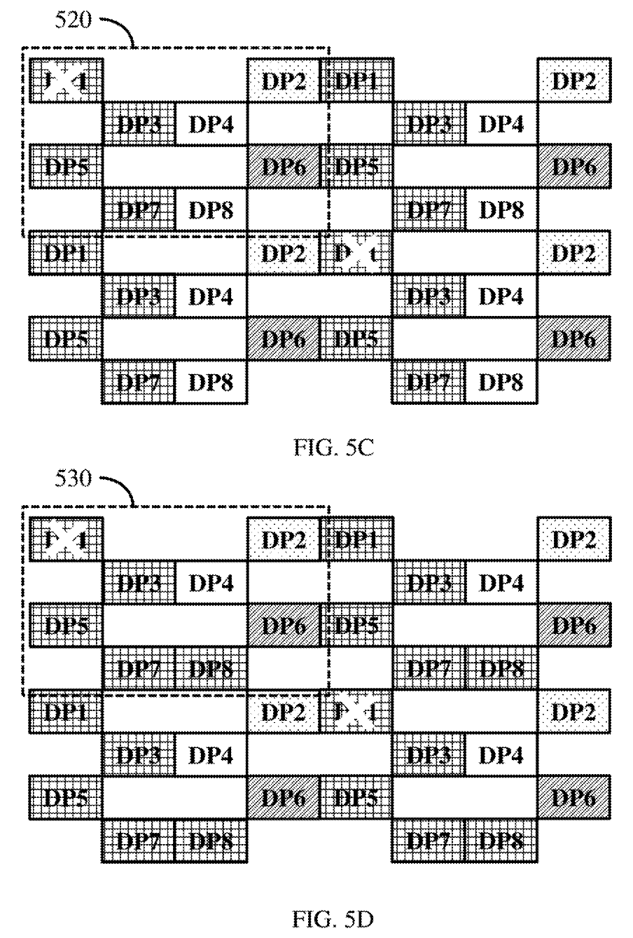

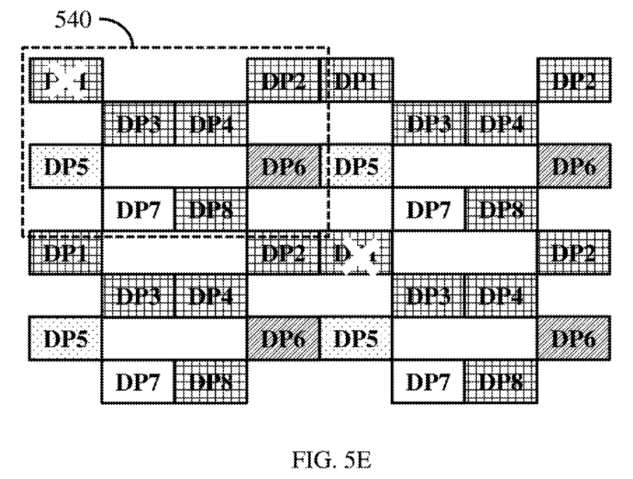

Referring to FIGS. 5A-5E , FIG. 5A is a schematic diagram illustrating a first pixel unit 500 configured in a first configuration according to at least one embodiment of the present disclosure. FIG. 5B is a schematic diagram illustrating a second pixel unit 510 configured in a second configuration reconfigured from the first pixel unit shown in FIG. 5A according to at least one embodiment of the present disclosure. FIG. 5C is a schematic diagram illustrating a second pixel unit 520 configured in a second configuration reconfigured from the first pixel unit shown in FIG. 5A according to at least another embodiment of the present disclosure. FIG. 5D is a schematic diagram illustrating a second pixel unit 530 configured in a second configuration reconfigured from the first pixel unit shown in FIG. 5A according to at least another embodiment of the present disclosure. FIG. 5E is a schematic diagram illustrating a second pixel unit 540 configured in a second configuration reconfigured from the first pixel unit shown in FIG. 5A according to at least another embodiment of the present disclosure.

In FIG. 5A, each first pixel unit 500 of the micro light emitting diode panel is configured according to the first configuration to include light emitting elements DP1, DP2, DP3, DP4, DP5, DP6, DP7, DP8. The light emitting elements DP1, DP2 are arranged sequentially in the same row, the light emitting elements DP3, DP4 are arranged sequentially in the same row, the light emitting elements DP5, DP6 are arranged sequentially in the same row, and the light emitting elements DP7, DP8 are arranged sequentially in the same row. The light emitting elements DP1, DP5 are arranged in the same column, the light emitting elements DP2, DP6 are arranged in the same column, the light emitting elements DP3, DP7 are arranged in the same column, and the light emitting elements DP4, DP8 are arranged in the same column. The light emitting elements DP1, DP3 are in different rows, and the light emitting elements DP3, DP4 are disposed between the light emitting elements DP1, DP2. The light emitting elements DP5, DP7 are in different rows, and the light emitting elements DP7, DP8 are disposed between the light emitting elements DP5, DP6. The light emitting elements DP2, DP5 emit the first color light (e.g., blue light, represented by dots), the light emitting elements DP3, DP4, DP7, DP8 emit the second color light (e.g., green light, represented by blank spaces), and the light emitting elements DP1, DP6 emit the third color light (e.g., red light, represented by slashes). In this embodiment, the first configuration in FIG. 5A is a 2-in-1 arrangement, in which two green sub-pixels are disposed between each pair of blue and red sub-pixels.

In FIG. 5B, each first pixel unit 500 is reconfigured from the first configuration into the second configuration to form the second pixel unit 510, and the second pixel unit 510 includes the light emitting elements DP1, DP2, DP3, DP4, DP5, DP6, DP7, DP8. Assuming that the light emitting element DP1 is a defective sub-pixel (indicated by an “X”), the light emitting element DP1, along with the light emitting elements DP2, DP7, DP8, will be disabled (indicated by grids), even if the light emitting elements DP2, DP7, DP8 are functioning normally. In this way, the second pixel unit 510 only uses the light emitting elements DP3, DP4, DP5, DP6 as a single pixel for display. Alternatively, the light emitting element DP3, along with the light emitting elements DP1, DP2, DP4, will be disabled, and the second pixel unit 510 only uses the light emitting elements DP5, DP6, DP7, DP8 as a single pixel for display. Similarly, if the light emitting element DP5 is a defective sub-pixel (not shown), the light emitting element DP5, along with the light emitting elements DP6, DP7, DP8, will be disabled. In this case, the second pixel unit 510 only uses the light emitting elements DP1, DP2, DP3, DP4 as a single pixel for display. The same principle applies to defective sub-pixels in other locations, and will not be repeated here. In this embodiment, the second configuration is also a 2-in-1 arrangement, and the second pixel unit 510 includes one red sub-pixel, one blue sub-pixel, and two green sub-pixels.

In another embodiment, as shown in FIG. 5C, each first pixel unit 500 is reconfigured from the first configuration into the second configuration to form the second pixel unit 520, and the second pixel unit 520 includes the light emitting elements DP1, DP2, DP3, DP4, DP5, DP6, DP7, DP8. Assuming that the light emitting element DP1 is a defective sub-pixel (indicated by an “X”), the light emitting element DP1, along with the light emitting elements DP3, DP5, DP7, will be disabled (indicated by grids). In this way, the second pixel unit 520 only uses the light emitting elements DP2, DP4, DP6, DP8 as a single pixel for display. Similarly, if the light emitting element DP2 is a defective sub-pixel (not shown), the light emitting element DP2, along with the light emitting elements DP4, DP6, DP8, will be disabled. In this case, the second pixel unit 520 only uses the light emitting elements DP1, DP3, DP5, DP7 as a single pixel for display. The same principle applies to defective sub-pixels in other locations, and will not be repeated here. In this embodiment, two adjacent second pixel units 520 arranged in the second configuration may form a diamond-shaped arrangement.

In another embodiment, as shown in FIG. 5D, each first pixel unit 500 is reconfigured from the first configuration into the second configuration to form the second pixel unit 530, and the second pixel unit 530 includes the light emitting elements DP1, DP2, DP3, DP4, DP5, DP6, DP7, DP8. Assuming that the light emitting element DP1 is a defective sub-pixel (indicated by an “X”), the light emitting element DP1, along with the light emitting elements DP3, DP5, DP7, DP8, will be disabled (indicated by grids). In this way, the second pixel unit 530 only uses the light emitting elements DP2, DP4, DP6 as a single pixel for display. Similarly, if the light emitting element DP2 is a defective sub-pixel (not shown), the light emitting element DP2, along with the light emitting elements DP4, DP6, DP7, DP8, will be disabled. In this case, the second pixel unit 530 only uses the light emitting elements DP1, DP3, DP5 as a single pixel for display. The same principle applies to defective sub-pixels in other locations, and will not be repeated here. In this embodiment, the second configuration is an RGB strip arrangement, and the second pixel unit 530 includes one red sub-pixel, one green sub-pixel, and one blue sub-pixel.

In another embodiment, as shown in FIG. 5E, each first pixel unit 500 is reconfigured from the first configuration into the second configuration to form the second pixel unit 540, and the second pixel unit 540 includes the light emitting elements DP1, DP2, DP3, DP4, DP5, DP6, DP7, DP8. Assuming that the light emitting element DP1 is a defective sub-pixel (indicated by an “X”), the light emitting element DP1, along with the light emitting elements DP2, DP3, DP4, DP8, will be disabled (indicated by grids). In this way, the second pixel unit 540 only uses the light emitting elements DP5, DP6, DP7 as a single pixel for display. Alternatively, the light emitting element DP1, along with the light emitting elements DP2, DP3, DP4, DP7, will be disabled, and the second pixel unit 540 only uses the light emitting elements DP5, DP6, DP8 as a single pixel for display. Alternatively, the light emitting element DP1, along with the light emitting elements DP2, DP4, DP7, DP8, will be disabled, and the second pixel unit 540 only uses the light emitting elements DP3, DP5, DP6 as a single pixel for display. Alternatively, the light emitting element DP1, along with the light emitting elements DP2, DP3, DP7, DP8, will be disabled, and the second pixel unit 540 only uses the light emitting elements DP4, DP5, DP6 as a single pixel for display. Similarly, if the light emitting element DP5 is a defective sub-pixel (not shown), the light emitting element DP5, along with the light emitting elements DP3, DP6, DP7, DP8, will be disabled. In this case, the second pixel unit 540 only uses the light emitting elements DP1, DP2, DP4 as a single pixel for display. Alternatively, the light emitting element DP5, along with the light emitting elements DP4, DP6, DP7, DP8, will be disabled, and the second pixel unit 540 only uses the light emitting elements DP1, DP2, DP3 as a single pixel for display. The same principle applies to defective sub-pixels in other locations, and will not be repeated here. In this embodiment, the second configuration is an RGB strip arrangement, and the second pixel unit 540 includes one red sub-pixel, one green sub-pixel, and one blue sub-pixel.

In summary, in at least one embodiment of the method for driving a micro light emitting diode panel of the present disclosure, the first pixel unit initially configured on the micro light emitting diode panel may include multiple light emitting elements emitting the same color light as sub-pixels. Once a defective sub-pixel occurs, the light emitting elements at the location of the defective sub-pixel and at the corresponding locations can be disabled, and the non-disabled light emitting elements can be reconfigured to form a regularly arranged second pixel unit to display the image, thereby avoiding mura formation. Since there is no need to repair the light emitting elements at the corresponding defective sub-pixel locations, the complexity and time required for the manufacturing process can be significantly reduced. Furthermore, even if a micro light emitting diode panel has been manufactured and defective sub-pixels have formed after a period of use, the image can still be displayed by reconfiguring the pixel units, and mura formation can be avoided.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims.

What is claimed is:

1. A method for driving a micro light emitting diode panel, comprising:
determining whether a plurality of light emitting elements included in the micro light emitting diode panel are abnormal, wherein the light emitting elements include a plurality of light emitting elements emitting a first color light, a plurality of light emitting elements emitting a second color light and a plurality of light emitting elements emitting a third color light, and the light emitting elements are arranged in a first configuration to form a plurality of first pixel units, wherein the first color light, the second color light and the third color light are all different;
in response to at least one of the light emitting elements is abnormal, disabling the at least one of the light emitting elements and a portion of the light emitting elements corresponding to the at least one of the light emitting elements;
reconfiguring the light emitting elements being non-disabled from the first configuration into a second configuration to form a plurality of second pixel units; and
adjusting driving currents provided to the light emitting elements being non-disabled according to the second configuration.

2. The method of claim 1, wherein one of the first pixel units is configured to comprise a first light emitting element, a second light emitting element, a third light emitting element, a fourth light emitting element, a fifth light emitting element and a sixth light emitting element, wherein the first light emitting element, the second light emitting element and the third light emitting element are arranged sequentially in a first row, and the fourth light emitting element, the fifth light emitting element and the sixth light emitting element are arranged sequentially in a second row, wherein the first light emitting element and fourth light emitting element are arranged in a first column and emit the first color light, the second light emitting element and the fifth light emitting element are arranged in a second column and emit the second color light, and the third light emitting element and the sixth light emitting element are arranged in a third column and emit the third color light.

3. The method of claim 2, wherein one of the second pixel units is configured to comprise the first light emitting element, the second light emitting element, the third light emitting element, the fourth light emitting element, the fifth light emitting element and the sixth light emitting element, wherein the first light emitting element, the second light emitting element and the third light emitting element are disabled; or the fourth light emitting element, the fifth light emitting element and the sixth light emitting element are disabled.

4. The method of claim 2, wherein one of the second pixel units is configured to comprise the first light emitting element, the second light emitting element, the third light emitting element, the fourth light emitting element, the fifth light emitting element and the sixth light emitting element, wherein the first light emitting element, the third light emitting element and the fifth light emitting element are disabled; or the second light emitting element, the fourth light emitting element and the sixth light emitting element are disabled.

5. The method of claim 2, wherein one of the second pixel units is configured to comprise the first light emitting element, the second light emitting element, the third light emitting element, the fourth light emitting element, the fifth light emitting element and the sixth light emitting element, wherein the first light emitting element and the third light emitting element are disabled; or the fourth light emitting element and the sixth light emitting element are disabled.

6. The method of claim 2, wherein one of the second pixel units is configured to comprise the first light emitting element, the second light emitting element, the third light emitting element, the fourth light emitting element, the fifth light emitting element and the sixth light emitting element, wherein the first light emitting element and the sixth light emitting element are disabled; or the third light emitting element and the fourth light emitting element are disabled.

7. The method of claim 1, wherein one of the first pixel units is configured to comprise a first light emitting element, a second light emitting element, a third light emitting element, a fourth light emitting element, a fifth light emitting element, a sixth light emitting element, a seventh light emitting element and an eighth light emitting element, wherein the first light emitting element, the second light emitting element, the third light emitting element and the fourth light emitting element are arranged sequentially in a first row, and the fifth light emitting element, the sixth light emitting element, the seventh light emitting element and the eighth light emitting element are arranged sequentially in a second row, wherein the first light emitting element and the fifth light emitting element are arranged in a first column, the second light emitting element and the sixth light emitting element are arranged in a second column, the third light emitting element and the seventh light emitting element are arranged in a third column, and the fourth light emitting element and the eighth light emitting element are arranged in a fourth column, wherein the first light emitting element and the seventh light emitting element emit the first color light, the second light emitting element, the fourth light emitting element, the sixth light emitting element and the eighth light emitting element emit the second color light, and the third light emitting element and the fifth light emitting element emit the third color light.

8. The method of claim 7, wherein one of the second pixel units is configured to comprise the first light emitting element, the second light emitting element, the third light emitting element, the fourth light emitting element, the fifth light emitting element, the sixth light emitting element, the seventh light emitting element and the eighth light emitting element, wherein the first light emitting element, the second light emitting element, the third light emitting element and the fourth light emitting element are disabled; or the fifth light emitting element, the sixth light emitting element, the seventh light emitting element and the eighth light emitting element are disabled.

9. The method of claim 7, wherein one of the second pixel units is configured to comprise the first light emitting element, the second light emitting element, the third light emitting element, the fourth light emitting element, the fifth light emitting element, the sixth light emitting element, the seventh light emitting element and the eighth light emitting element, wherein the first light emitting element, the third light emitting element , the sixth light emitting element and the eighth light emitting element are disabled; or the second light emitting element, the fourth light emitting element, the fifth light emitting element and the seventh light emitting element are disabled.

10. The method of claim 7, wherein one of the second pixel units is configured to comprise the first light emitting element, the second light emitting element, the third light emitting element, the fourth light emitting element, the fifth light emitting element, the sixth light emitting element, the seventh light emitting element and the eighth light emitting element, wherein the first light emitting element, the second light emitting element, the third light emitting element, the fourth light emitting element and the eighth light emitting element are disabled; or the fourth light emitting element, the fifth light emitting element, the sixth light emitting element, the seventh light emitting element and the eighth light emitting element are disabled.

11. The method of claim 1, wherein one of the first pixel units is configured to comprise a first light emitting element, a second light emitting element, a third light emitting element, a fourth light emitting element, a fifth light emitting element, a sixth light emitting element, a seventh light emitting element and an eighth light emitting element, wherein the first light emitting element and the second light emitting element are arranged sequentially in a first row, the third light emitting element and the fourth light emitting element are arranged sequentially in a second row, the fifth light emitting element and the sixth light emitting element are arranged sequentially in a third row, and the seventh light emitting element and the eighth light emitting element are arranged sequentially in a fourth row, wherein the first light emitting element and the fifth light emitting element are arranged in a first column, the second light emitting element and the sixth light emitting element are arranged in a second column, the third light emitting element and the seventh light emitting element are arranged in a third column, and the fourth light emitting element and the eighth light emitting element are arranged in a fourth column, wherein the third light emitting element is in a different row from the first light emitting element and the fifth light emitting element, and the third light emitting element is in a different column from the first light emitting element and the second light emitting element, wherein the sixth light emitting element is in a different row from the third light emitting element and the seventh light emitting element, and the sixth light emitting element is in a different column from the third light emitting element and the fourth light emitting element, wherein the third light emitting element is disposed between the first light emitting element, the second light emitting element, the fifth light emitting element and the sixth light emitting element, and the sixth light emitting element is disposed between the third light emitting element, the fourth light emitting element, the seventh light emitting element and the eighth light emitting element, wherein the second light emitting element and the fifth light emitting element emit the first color light, the third light emitting element, the fourth light emitting element, the seventh light emitting element and the eighth light emitting element emit the second color light, and the first light emitting element and the sixth light emitting element emit the third color light.

12. The method of claim 11, wherein one of the second pixel units is configured to comprise the first light emitting element, the second light emitting element, the third light emitting element, the fourth light emitting element, the fifth light emitting element, the sixth light emitting element, the seventh light emitting element and the eighth light emitting element, wherein the first light emitting element, the second light emitting element, the third light emitting element and the fourth light emitting element are disabled; or the first light emitting element, the second light emitting element, the seventh light emitting element and the eighth light emitting element are disabled; or the fifth light emitting element, the sixth light emitting element, the seventh light emitting element and the eighth light emitting element are disabled.

13. The method of claim 11, wherein one of the second pixel units is configured to comprise the first light emitting element, the second light emitting element, the third light emitting element, the fourth light emitting element, the fifth light emitting element, the sixth light emitting element, the seventh light emitting element and the eighth light emitting element, wherein the first light emitting element, the fourth light emitting element, the fifth light emitting element and the eighth light emitting element are disabled; or the first light emitting element, the third light emitting element, the fifth light emitting element and the seventh light emitting element are disabled; or the second light emitting element, the fourth light emitting element, the sixth light emitting element and the eighth light emitting element are disabled.

14. The method of claim 11, wherein one of the second pixel units is configured to comprise the first light emitting element, the second light emitting element, the third light emitting element, the fourth light emitting element, the fifth light emitting element, the sixth light emitting element, the seventh light emitting element and the eighth light emitting element, wherein the first light emitting element, the third light emitting element, the fifth light emitting element, the seventh light emitting element and the eighth light emitting element are disabled; or the first light emitting element, the fourth light emitting element, the fifth light emitting element, the seventh light emitting element and the eighth light emitting element are disabled; or the second light emitting element, the fourth light emitting element, the sixth light emitting element, the seventh light emitting element and the eighth light emitting element are disabled.

15. The method of claim 11, wherein one of the second pixel units is configured to comprise the first light emitting element, the second light emitting element, the third light emitting element, the fourth light emitting element, the fifth light emitting element, the sixth light emitting element, the seventh light emitting element and the eighth light emitting element, wherein the first light emitting element, the second light emitting element, the third light emitting element, the fourth light emitting element and the eighth light emitting element are disabled; or the first light emitting element, the second light emitting element, the fourth light emitting element, the seventh light emitting element and the eighth light emitting element are disabled; or the fourth light emitting element, the fifth light emitting element, the sixth light emitting element, the seventh light emitting element and the eighth light emitting element are disabled.

16. The method of claim 1, wherein one of the first pixel units is configured to comprise a first light emitting element, a second light emitting element, a third light emitting element, a fourth light emitting element, a fifth light
emitting element, a sixth light emitting element, a seventh light emitting element and an eighth light emitting element, wherein the first light emitting element and the second light emitting element are arranged sequentially in a first row, the third light emitting element and the fourth light emitting element are arranged sequentially in a second row, the fifth light emitting element and the sixth light emitting element are arranged sequentially in a third row, and the seventh light emitting element and the eighth light emitting element are arranged sequentially in a fourth row, wherein the first light emitting element and the fifth light emitting element are arranged in a first column, the second light emitting element and the sixth light emitting element are arranged in a second column, the third light emitting element and the seventh light emitting element are arranged in a third column, and the fourth light emitting element and the eighth light emitting element are arranged in a fourth column, wherein the third light emitting element is in a different row from the first light emitting element, and the third light emitting element and the fourth light emitting element are disposed between the first light emitting element and the second light emitting element, wherein the seventh light emitting element is in a different row from the fifth light emitting element, and the seventh light emitting element and the eighth light emitting element are disposed between the fifth light emitting element and the sixth light emitting element, wherein the second light emitting element and the fifth light emitting element emit the first color light, the third light emitting element, the fourth light emitting element, the seventh light emitting element and the eighth light emitting element emit the second color light, and the first light emitting element and the sixth light emitting element emit the third color light.

17. The method of claim 16, wherein one of the second pixel units is configured to comprise the first light emitting element, the second light emitting element, the third light emitting element, the fourth light emitting element, the fifth light emitting element, the sixth light emitting element, the seventh light emitting element and the eighth light emitting element, wherein the first light emitting element, the second light emitting element, the third light emitting element and the fourth light emitting element are disabled; or the first light emitting element, the second light emitting element, the seventh light emitting element and the eighth light emitting element are disabled; or the fifth light emitting element, the sixth light emitting element, the seventh light emitting element and the eighth light emitting element are disabled.

18. The method of claim 16, wherein one of the second pixel units is configured to comprise the first light emitting element, the second light emitting element, the third light emitting element, the fourth light emitting element, the fifth light emitting element, the sixth light emitting element, the seventh light emitting element and the eighth light emitting element, wherein the first light emitting element, the third light emitting element, the fifth light emitting element and the seventh light emitting element are disabled; or the second light emitting element, the fourth light emitting element, the sixth light emitting element and the eighth light emitting element are disabled.

19. The method of claim 16, wherein one of the second pixel units is configured to comprise the first light emitting element, the second light emitting element, the third light emitting element, the fourth light emitting element, the fifth light emitting element, the sixth light emitting element, the seventh light emitting element and the eighth light emitting element, wherein the first light emitting element, the third light emitting element, the fifth light emitting element, the seventh light emitting element and the eighth light emitting element are disabled; or the second light emitting element, the fourth light emitting element, the sixth light emitting element, the seventh light emitting element and the eighth light emitting element are disabled.

20. The method of claim 16, wherein one of the second pixel units is configured to comprise the first light emitting element, the second light emitting element, the third light emitting element, the fourth light emitting element, the fifth light emitting element, the sixth light emitting element, the seventh light emitting element and the eighth light emitting element, wherein the first light emitting element, the second light emitting element, the third light emitting element, the fourth light emitting element and the eighth light emitting element are disabled; or the first light emitting element, the second light emitting element, the third light emitting element, the fourth light emitting element and the seventh light emitting element are disabled; or the first light emitting element, the second light emitting element, the fourth light emitting element, the seventh light emitting element and the eighth light emitting element are disabled; or the first light emitting element, the second light emitting element, the third light emitting element, the seventh light emitting element and the eighth light emitting element are disabled; or the third light emitting element, the fifth light emitting element, the sixth light emitting element, the seventh light emitting element and the eighth light emitting element are disabled; or the fourth light emitting element, the fifth light emitting element, the sixth light emitting element, the seventh light emitting element and the eighth light emitting element are disabled.

21. The method of claim 1, wherein reconfiguring the light emitting elements being non-disabled from the first configuration into a second configuration to form a plurality of second pixel units comprises:
preferring a configuration with a minimum total number of the light emitting elements being disabled to form the second pixel units.
